(19) United States
(12) Patent Application Publication
(10) Pub. No.: US 2011/0078709 A1
(43) Pub. Date: Mar. 31, 2011

(54) Distributed Management of Native Interface Metadata and Arrays

(75) Inventors: Michael Dawson, Ontario (CA); Graeme Johnson, Ontario (CA)

(73) Assignee: IBM CORPORATION, Armonk, NY (US)

(21) Appl. No.: 12/889,644

(22) Filed: Sep. 24, 2010

(30) Foreign Application Priority Data
Sep. 25, 2009 (CA) 2678098

(51) Int. Cl. G06F 9/46; G06F 13/00

(52) U.S. Cl. 719/330

(57) ABSTRACT

An illustrative embodiment provides a computer-implemented process for distributed management of native interface arrays. The computer-implemented process obtains an array type native interface call in a first system from a caller in a second system, identifies an array type of the array type native interface call to form an identified array type, and requests array elements associated with the identified array type to form requested array elements, wherein added metadata is associated with the requested array elements. The computer-implemented process builds an enhanced data structure using the requested array elements and the associated added metadata and returns a pointer within the enhanced data structure to the caller. The pointer can be used by the caller to manipulate array data of the array elements, and the first system can calculate an address of the added metadata in constant time from the pointer.

### PRIORITY CLAIM

The present application claims benefit of priority under 35 USC §120, §365 to the previously filed U.S. Pat. No. 2,678,098 entitled, “Distributed Management of Native Metadata and Arrays” with a priority date of Sep. 25, 2009. The content of that application is incorporated by reference herein.

### BACKGROUND

1. Technical Field

This disclosure relates generally to distributed processing in data processing systems and more specifically to distributed management of native interface arrays.

2. Description of the Related Art

In a Java™ programming environment the Java Virtual Machine (JVM™) implementations support the Java Native Interface (JNI™). The Java Native Interface is a mechanism enabling Java code to call methods written in other programming languages such as C and C++. The other programming language code is known as native code in the context of the Java Native Interface. Other programming language methods may also call Java programming methods using the Java Native Interface support. Typically, the code written in Java as well as the native code executes in the same process, by the same thread as the program execution transitions between the two programming environments.

However, implementations exist in which a Java virtual machine is created that enables the native code to run in one or more remote execution containers. The remote execution containers may be hosted in separate processes on the same or different machines from where the Java code is executed. The native code is unaware that it is executed separately from the Java virtual machine. The separation of the native code from the Java code prevents misbehaved native code from destabilizing the Java virtual machine and enables the native code to operate in a different environment, for example, using a different security context, or different pointer width, than the Java virtual machine supports.

In an environment in which the Java virtual machine is split, the remote execution containers are hosted in separate processes on different machines from where the Java code is executed. The cost of the calls between Java and native code have much greater overhead and latency resulting in the need to reduce round-trips between environments where possible.

In such a system where native code executes remotely from the Java virtual machine, the native code invokes Java Native Interface methods to interact with the Java virtual machine. The Get<Type>ArrayElements( ) and GetPrimitiveArrayCritical( ) methods return a pointer to memory location which contains elements for a Java program array. The native code can read and modify the elements of the array using the pointer and then commit the changes by calling a matching method which is one of Release<Type>ArrayElements( ) or ReleasePrimitiveArrayCritical( ). The following discussion only deals with an array type subset of the native interface method invocations and not all native interface calls in general.

The Java Native Interface specification allows the pointer to either be a pointer to a copy of the elements or a pointer to the elements. If the pointer is a copy, the elements are then copied back to the actual elements when the ReleaseXXX call is made. A significant requirement therefore is that a call to the ReleaseXXX method must supply the original pointer that was returned by the GetXXX call. For example, a native code is returned the pointer to the array elements as buffer_j and later the native code must pass this same original pointer buffer_j back to commit or closeout the operation.

In an example of a Java virtual machine in which native code runs remotely, an invocation of a GetXXX method in the local Java virtual machine will return a pointer in the local Java virtual machine address space. A copy of the elements referenced by the pointer must be sent to the remote execution container, where the native code is executing. Because the native code resides in another address space, the native code will be operating on a different buffer than was originally created by the GetXXX( ) call local to the Java virtual machine. The remote Java Native Interface implementation must ensure that the copy of the elements and the original buffer from the Java virtual machine address space remain synchronized in a manner that is transparent to the native code method.

In addition, when the native code is running on a different platform, for example where the byte order is reversed or pointer width varies, the data may require conversion as the data passes from the remote execution container back to the Java virtual machine. The conversion or transformation will require additional information about the array such as the type of the elements within the array and the number of elements. The required information is available from the Java virtual machine through remote procedure calls, for example, GetArrayLength( ), that imposes a performance penalty in the form of extra processing time and delay for the round trips.

An example implementation would typically send the original pointer, buffer_j, along with the array elements during the transfer from the Java virtual machine to the remote execution container and maintain the relationship between Java virtual machine and remote buffers using a hash table or similar data structure. When a ReleaseXXX call occurs in a native interface method the Java virtual machine can readily obtain the original buffer_j handle via a hash table lookup and obtain additional metadata via a series of Java Native Interface calls. The implementation would typically perform poorly due to the additional remote calls and the need to do lookups in the hash table. The implementation would also add additional complexity in order to manage the lifetime of hash table entries.

### BRIEF SUMMARY

According to one embodiment, a computer-implemented method provides distributed management of native interface arrays. The computer-implemented process obtains an array type native interface call in a first system from a caller in a second system, identifies an array type of the array type native interface call to form an identified array type, and requests array elements associated with the identified array type to form requested array elements, wherein added metadata is associated with the requested array elements. The computer-implemented process builds an enhanced data structure using the requested array elements and the associated added metadata and returns a pointer within the enhanced data structure to the caller, wherein the pointer can be used by the caller to manipulate array data of the array elements and the first system can calculate an address of the added metadata in constant time from the pointer.

According to another embodiment, a computer program product, comprising a computer recordable medium containing computer executable program code stored thereon, provides distributed management of native interface arrays. The computer executable program code comprising computer executable program code for obtaining an array type native interface call in a first system from a caller in a second system, computer executable program code for identifying an array type of the array type native interface call to form an identified array type, computer executable program code for requesting array elements associated with the identified array type to form requested array elements, wherein added metadata is associated with the requested array elements, computer executable program code for building an enhanced data structure using the requested array elements and the associated added metadata, and computer executable program code for returning a pointer within the enhanced data structure to the caller, wherein the pointer can be used by the caller to manipulate array data of the array elements and the first system can calculate an address of the added metadata in constant time from the pointer.

According to another embodiment, an apparatus for distributed management of native interface arrays, comprises a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric, wherein the processor unit executes the computer executable program code to direct the apparatus to: obtain an array type native interface call in a first system from a caller in a second system; identify an array type of the array type native interface call to form an identified array type; request array elements associated with the identified array type to form requested array elements, wherein added metadata is associated with the requested array elements; build an enhanced data structure using the requested array elements and the associated added metadata; and return a pointer within the enhanced data structure to the caller, wherein the pointer can be used by the caller to manipulate array data of the array elements and the first system can calculate an address of the added metadata in constant time from the pointer.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system operable for various embodiments of the disclosure;

FIG. 2; is a block diagram of a workflow between a local system and a remote system using an enhanced data structure, in accordance with various embodiments of the disclosure;

FIG. 3 is a flowchart of a high level process building the enhanced data structure of FIG. 2, in accordance with one embodiment of the disclosure;

FIG. 4 is a flowchart of a detail view of building the enhanced data structure process of FIG. 3, in accordance with one embodiment of the disclosure; and

FIG. 5 is a flowchart of a process of releasing the enhanced data structure of FIG. 2, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product tangibly embodied in any medium of expression with computer usable program code embodied in the medium.

Computer program code for carrying out operations of the present disclosure may be written in any combination of one or more programming languages, including an object oriented programming language such as Java™, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

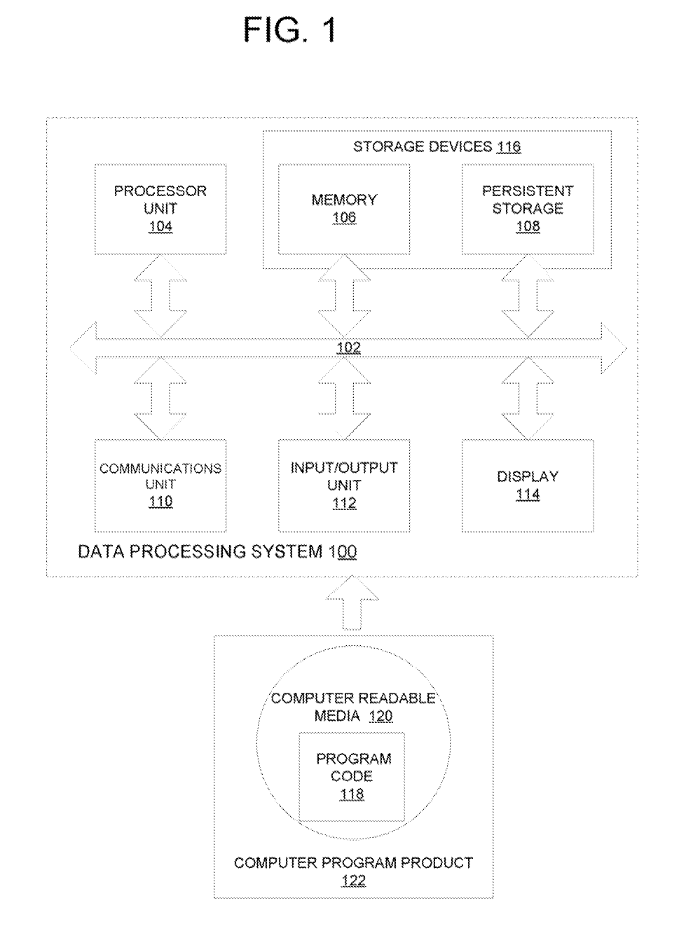

Turning now to FIG. 1 a block diagram of an exemplary data processing system operable for various embodiments of the disclosure is presented. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. As another example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable media 120 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 may be any hardware apparatus that may store data. Memory 106, persistent storage 108 and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

A communication network to form a set of data processing systems may interconnect a number of data processing systems. The set comprises one or more data processing systems, such as data processing system 100.

According to an illustrative embodiment, a computer-implemented process for distributed management of native interface metadata and arrays is presented. The computer-implemented process provides a capability to receive a native interface call of an array type and provide an enhanced data structure in response. The enhanced data structure contains added metadata as well as a set of array elements to satisfy the request. A start of array pointer allows calling functions of the remote system to access array elements and an original local pointer associated with a data location in the local system. Either a local or a remote system may create the enhanced data structure for use by the remote system.

Using a pair of systems such as data processing system 100 of FIG. 1 as an example, an illustrative embodiment provides a computer-implemented process stored in memory 106, executed by processor unit 104 of a first system, to receive a Java Native Interface call from a remote execution container on a second system. In this example processor unit 104 of the receiving first system responds to the array type call by building an enhanced data structure in memory 106. The enhanced data structure may be created from array elements pulled from persistent storage 108 or other storage locations such as storage devices 116. The enhanced data structure is then transmitted to the remote second system by communications unit 110 for use by the methods of the remote second system. Upon completion, the remote second system issues a release native interface call that obtains the original local pointer from the enhanced data structure and returns the original local pointer to the local first system. In this and other examples first and second system can be implemented on separate physical systems or logical systems. Illustrative embodiments provide a formation for the additional metadata that can be retrieved in constant time from the start of array pointer returned to the caller. The formation further provides the caller with a capability to reduce the number of round trips between the virtual machine and remote execution container.

In an alternative embodiment, program code 118 containing the computer-implemented process may be stored within computer readable media 120 as computer program product 122. In another illustrative embodiment, the process for distributed management of native interface metadata and arrays, may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

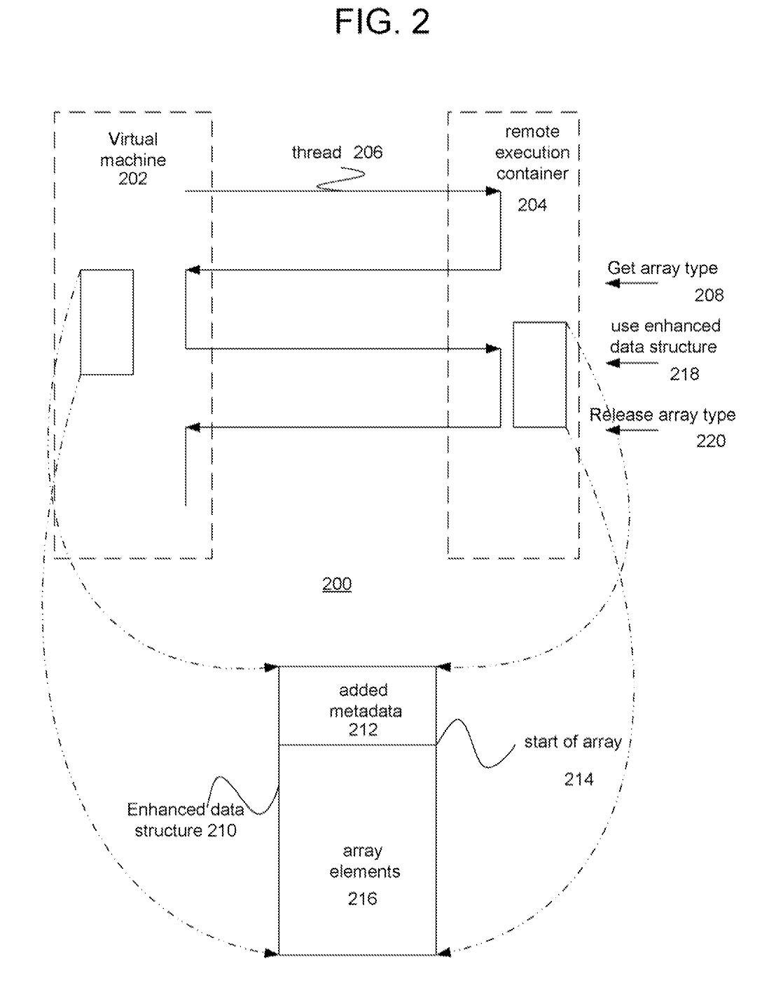

With reference to FIG. 2, a block diagram of a workflow between a local system and a remote system using an enhanced data structure, in accordance with various embodiments of the disclosure is presented.

System 200 is an example of a pair of first and second systems, such as system 100 of FIG. 1 in communication to form a local and a remote system combination. A Java virtual machine implementation of virtual machine 202 represents a local system as a first system in the example, and remote execution container 204 represents the remote system as a second system. Both first and second systems may have Java virtual machine implementations. Remote execution container 204 of the second system represents an implementation using a programming language such as C or C++ with Java Native Interface support.

Thread 206 is shown executing a function in remote execution container 204 from a first system of virtual machine 202. The function being executed in the second system of remote execution container 204 invokes a native interface call to virtual machine 202 that is one of the Get<Type>ArrayElements( ) and GetPrimitiveArrayCritical( ) calls of Get array type 208. Virtual machine 202 responds by packaging the needed information into an enhanced data structure 210.

Enhanced data structure 210 represents a collection of information comprising added metadata 212, start of array 214 and array elements 216. Added metadata 212 contains information that is helpful to manage the exchange of array data. For example, added metadata 212 contains, but is not limited to, array type information, array length information, and an original pointer to array data on virtual machine 202.

Array type information represents the information needed to identify transformations that may be necessary to allow the information from the virtual machine environment to be used in the remote execution environment. Array length information is required to determine the number of elements that need to be transformed and the storage space requirements of the information. The original pointer returned by GetXXX call, start of array 214, is a pointer to array elements 216 that can be manipulated by the caller, and is the pointer that must be returned to the ReleaseXXX call of release array type 220 to complete processing. Packaging the information in the enhanced data structure 210 enables metadata 212 to be located in constant time. Then, given the pointer returned by GetXXX call, start of array 214 is then passed back in the Release XXX call of release array type 220, which provides a capability to have the information available for use by virtual machine 202 without change to the caller.

Use enhanced data structure 218 is performed within remote execution container 204 using the information provided in a manner transparent to the invoking function. Upon completion of the task, the caller, just as in an unmodified implementation, passes the pointer returned in get array type 208 to release array type 220. The underlying implementation of the release computes the location of added metadata 212 directly from the pointer passed, which is start of the array 216, and uses the information from enhanced data structure 210, transparent to the caller.

Enhanced data structure 210 is shown within both virtual machine 202 and remote execution container 204. In one embodiment, enhanced data structure 210 can be built within virtual machine 202 and transmitted to remote execution container 204. In another embodiment, enhanced data structure 210 can be built within remote execution container 204 from information retrieved from or sent by virtual machine 202. The location of the build may typically be determined based on performance and quantity and availability of information.

The implementation of the process just described provides an enhanced virtual machine 202 and remote execution container 204 to maintain the standard interface of the Java Native Interface protocol. The underlying support for enhanced data structure 210 manages the formation and format of the new information, transparent to users of the functions. The technique just described provides a capability for efficiently handling the additional array metadata required in the use of ReleaseXXX calls. The support removes the need for additional remote calls from remote execution container 204 to manage the array data. Further, the support described in the illustrative embodiment does not require a separate cache to hold the original local pointer in the address space of virtual machine 202, while bundling additional array metadata with array manipulation requests, and storing of the metadata in a form that allows efficient access to both array elements and metadata by the user in remote execution container 204.

When a GetXXX call is made from remote execution container 204, instead of returning the pointer returned in the address space of virtual machine 202, an instance of an enhanced data structure is transmitted across the process boundary between virtual machine 202 and remote execution container 204. A pointer to array elements 216 data is returned to the calling native implementation such that the calling native implementation is unaware of the additional metadata stored at the beginning of the structure. The calling native implementation can use the returned pointer to read and update the array elements as though execution had occurred in the same local process as virtual machine 202.

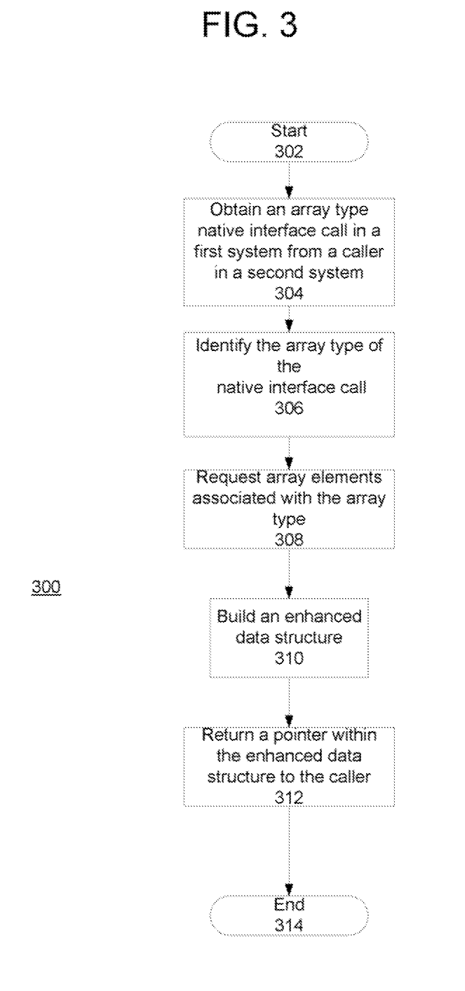

With reference to FIG. 3, a flowchart of a high level process of building the enhanced data structure of FIG. 2, in accordance with one embodiment of the disclosure is presented. Process 300 is an example method for building enhanced data structure 210 of system 200 of FIG. 2.

Process 300 starts (step 302) and obtains an array type native interface call from a caller (step 304). The array type call may be any of the calls involving the getting of array information such as those defined in the Java Native Interface protocol. Other calls may be ignored. For example, GetIntegerArrayElements( ) would be an expected and supported call.

The process identifies the array type of the native interface call is performed (step 306). Identification of the array type is required to ensure proper information is obtained with respect to the array. Having determined the array type, the process requests array elements (step 308). Requesting array elements obtains the data needed for the various elements of the particular call or array type. The array elements are obtained from the local virtual machine system as in virtual machine 202 of system 200 of FIG. 2. The process builds an enhanced data structure (step 310). The enhanced data structure comprises an array elements portion and an added metadata portion.

The process returns a pointer within the enhanced data structure to the caller (step 312), and the process 300 terminates thereafter (step 314). A pointer, start of array 216, is returned to allow the caller to manipulate the array elements as though the caller was accessing the elements before implementation of the enhanced data structure. No change is required to the caller to use the new capability. Support for use of enhanced data structure 210 is provided through implementations of modification to virtual machine 202 and remote execution container 204 and all of FIG. 2. Changes to the virtual machine and remote execution container implementations therefore make use of the enhanced data structure transparent to the caller by calculating the location of added metadata 212 from the address of array elements 216 of FIG. 2. The caller can manipulate array data of the array elements using the pointer and the first system can calculate an address of the added metadata in constant time from the pointer. The first system has a capability to calculate the address of the added metadata in an efficient manner regardless of the size of the added metadata, hence in constant time.

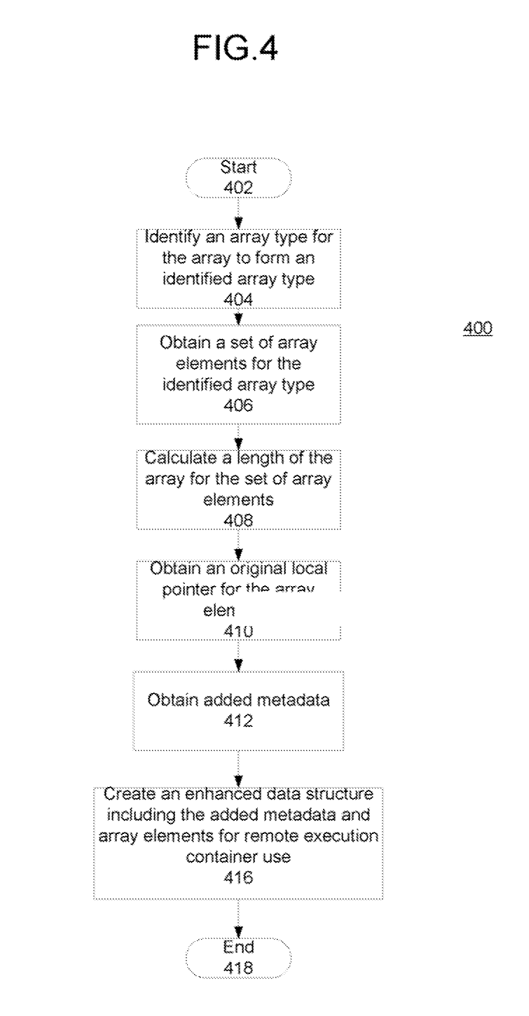

With reference to FIG. 4, a flowchart of a detail view of building the enhanced data structure of FIG. 2, in accordance with one embodiment of the disclosure is presented. Process 400 is a further example of method process 300 for building an enhanced data structure of FIG. 3.

Process 400 starts (step 402) and identifies an array type for the array to form an identified array type (step 404). The array type is identified to provide information regarding the number and size of elements that compose the array used in the function being invoked.

Having identified a particular array type, process 400 obtains a set of array elements for the identified array type (step 406). Because array types vary, the quantity and size of elements used will also vary according to the array type. The set of array elements comprises one or more elements as dictated by the array type. Based on the array type information and array elements obtained, the process 400 calculates a length of the array for the set of array elements (step 408). The calculation is used to determine the size required to contain the array elements within an enhanced data structure, and therefore the size of the enhanced data structure as well.

Process 400 obtains an original local pointer for the array elements (step 410). The original local pointer is obtained from the virtual machine having the data forming the array elements. The original local pointer is used to adhere to the conventions of the Java Native Interface protocol. The protocol requires the caller to return the original pointer obtained by the caller.

Process 400 obtains added metadata is performed (step 412). The added metadata provides additional information used to manipulate the array elements including the array type, array length and the original pointer. The information is used by the underlying implementation to hide transformations from the caller. Transforms may be required between a virtual machine implementation of one platform type and a remote execution container implemented on another different platform type. For example, array elements may need to be transformed between platforms using differing character code bases or byte order sequences.

Process 400 creates an enhanced data structure including added metadata and array elements for remote execution container use (step 416) is performed with process 400 terminating thereafter (step 418). The enhanced data set is created for the target remote execution container in a form that is ready for use by the remote execution container. As previously stated a process of create or build may be used on either, or a combination, of the first system of the virtual machine and the second system of the remote execution container systems. Although the build process may execute on a non-specific system, the information such as that comprising the array elements must come from the virtual machine system having access to that information.

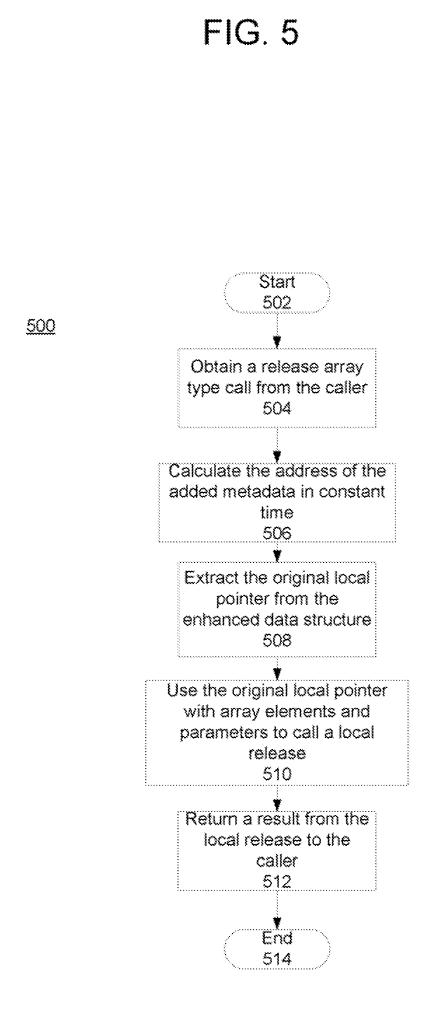

With reference to FIG. 5, a flowchart of a process of executing a release process using the enhanced data structure system of FIG. 2, in accordance with one embodiment of the disclosure is presented. Process 500 is an example of a method used to commit the operation and release the resources such as those contained within or referenced by enhanced data structure 210 of system 200 of FIG. 2.

Process 500 starts (step 502) and obtains a release array type call from the caller (step 504). The release array type call indicates that execution of a previous function has completed and the resources must be released. The release array type call represents a specific subset of methods within the Java Native Interface protocol.

Given the pointer to the array passed into the release call, process 500 calculates the address of the added metadata in constant time, which is added metadata 212 of FIG. 2 (step 506). Process 500 extracts the original local pointer from the enhanced data structure is performed (step 508). The original local pointer obtained in a prior GetXXX call must be returned on a corresponding release call. The underlying implementation of the support for the use of the enhanced data structure provides the necessary pointer location information allowing the function to obtain the original local pointer from the enhanced data structure.

Use the original local pointer along with the array elements and parameters passed in to call the local release (step 510). As previously stated, the original local pointer must be returned on a corresponding release call. Process 500 returns the result from the local release is performed (step 512), and process 500 terminates thereafter (step 514). The caller is not aware that the enhanced data structure was used because the implementation hides the support from the caller. Thus the original local pointer in the example of system 200 of FIG. 2 is returned to virtual machine 202 from remote execution container 204 as required by the Java Native Interface specification.

The caller does not have to make any change to use the enhanced data structure because the implementation hides the changes within the underlying implementation. Further, the implementation of the enhanced data structure support is manifested in modifications to the virtual machine implementation as well as the remote execution container implementation. The Java Native Interface remains the same, as does the result of invoking array type methods.

Illustrative embodiments thus provide a process, a computer program product and an apparatus for distributed management of native interface arrays. One illustrative embodiment provides a computer-implemented process with a capability for distributed management of native interface arrays.

The computer-implemented process of an illustrative embodiment provides a capability to obtain an array type native interface call in a first system from a caller in a second system, identify an array type of the array type native interface call to form an identified array type and request array elements associated with the identified array type to form requested array elements, wherein added metadata is associated with the requested array elements. The computer-implemented process builds an enhanced data structure using the requested array elements and the associated added metadata and returns a pointer within the enhanced data structure to the caller.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented process for distributed management of native interface arrays, the computer-implemented process comprising:
obtaining an array type native interface call in a first system from a caller in a second system;
identifying an array type of the array type native interface call to form an identified array type;
requesting array elements associated with the identified array type to form requested array elements, wherein added metadata is associated with the requested array elements;
building an enhanced data structure using the requested array elements and the associated added metadata; and
returning a pointer within the enhanced data structure to the caller, wherein the pointer can be used by the caller to manipulate array data of the array elements and the first system can calculate an address of the added metadata in constant time from the pointer.

2. The computer-implemented process of claim 1, wherein obtaining an array type native interface call from a caller further comprises:
receiving an array type native interface call in the first system from a function executing in the second system, wherein the second system is operating in a system separate from and in communication with the first system containing data comprising the array elements.

3. The computer-implemented process of claim 1, wherein the added metadata comprises a set of data including an array type, an array length and an original pointer to the array elements on the first system.

4. The computer-implemented process of claim 1, wherein building an enhanced data structure using the requested array elements and the associated added metadata further comprises:
building the enhanced data structure on a set of systems, wherein the set comprises one or more of the first system, the second system, and a combination of the first and second system.

5. The computer-implemented process of claim 1, wherein building the enhanced data structure further comprises:
calculating a length of array for the requested array elements;
obtaining an original local pointer to the requested array elements on the first system; and
obtaining added metadata associated with the requested array elements.

6. The computer-implemented process of claim 1, wherein building the enhanced data structure further comprises:
transforming the enhanced data structure from the first system to the second system for use by the second system.

7. The computer-implemented method of claim 1, further comprising:
obtaining a release array type call on the first system from the second system;
calculating an address of the enhanced data structure;
extracting the original local pointer from the enhanced data structure;
calling a local release function using the original local pointer with array elements and parameters previously passed; and
returning a result from the local release function.

8. A computer program product for distributed management of native interface arrays, the computer program product comprising:
a computer recordable medium containing computer executable program code stored thereon, the computer executable program code comprising:
computer executable program code for obtaining an array type native interface call in a first system from a caller in a second system;
computer executable program code for identifying an array type of the array type native interface call to form an identified array type;
computer executable program code for requesting array elements associated with the identified array type to form requested array elements, wherein added metadata is associated with the requested array elements;
computer executable program code for building an enhanced data structure using the requested array elements and the associated added metadata; and
computer executable program code for returning a pointer within the enhanced data structure to the caller, wherein the pointer can be used by the caller to manipulate array data of the array elements and the first system can calculate an address of the added metadata in constant time from the pointer.

9. The computer program product of claim 8, wherein computer executable program code for obtaining an array type native interface call from a caller further comprises:
computer executable program code for receiving an array type native interface call in the first system from a function executing in the second system, wherein the second system is operating in a system separate from and in communication with the first system containing data comprising the array elements.

10. The computer program product of claim 8, wherein the added metadata comprises a set of data including an array type, an array length and an original pointer to the array elements on the first system.

11. The computer program product of claim 8, wherein computer executable program code for building an enhanced data structure using the requested array elements and the associated added metadata further comprises:
computer executable program code for building the enhanced data structure on a set of systems, wherein the set comprises one or more of the first system, the second system, and a combination of the first system and the second system.

12. The computer program product of claim 8, wherein computer executable program code for building the enhanced data structure further comprises:
computer executable program code for calculating a length of array for the requested array elements;
computer executable program code for obtaining an original local pointer to the requested array elements on the first system; and
computer executable program code for obtaining added metadata associated with the requested array elements.

13. The computer program product of claim 8, wherein computer executable program code for building the enhanced data structure further comprises:
computer executable program code for transforming the enhanced data structure from the first system to the second system for use by the second system.

14. The computer program product of claim 8, further comprising:
computer executable program code for obtaining a release array type call on the first system from the second system;
computer executable program code for calculating an address of the enhanced data structure;
computer executable program code for extracting the original local pointer from the enhanced data structure;
computer executable program code for calling a local release function using the original local pointer with array elements and parameters previously passed; and
computer executable program code for returning a result from the local release function.

15. An apparatus for distributed management of native interface arrays, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
obtain an array type native interface call in a first system from a caller in a second system;
identify an array type of the array type native interface call to form an identified array type;
request array elements associated with the identified array type to form requested array elements, wherein added metadata is associated with the requested array elements;
build an enhanced data structure using the requested array elements and the associated added metadata; and
return a pointer within the enhanced data structure to the caller, wherein the pointer can be used by the caller to manipulate array data of the array elements and the first system can calculate an address of the added metadata in constant time from the pointer.

16. The apparatus of claim 15, wherein the processor unit further executes the computer executable code to obtain an array type native interface call from a caller further comprises to:
receive an array type native interface call in the first system from a function executing in the second system, wherein the second system is operating in a system separate from and in communication with the first system containing data comprising the array elements.

17. The apparatus of claim 15, wherein the added metadata comprises a set of data including an array type, an array length and an original pointer to the array elements on the first system.

18. The apparatus of claim 15, wherein the processor unit further executes the computer executable code to build an enhanced data structure using the requested array elements and the associated added metadata further comprises to:
build the enhanced data structure on a set of systems, wherein the set comprises one or more of the first system, the second system, and a combination of the first and second system.

19. The apparatus of claim 15, wherein the processor unit further executes the computer executable code to build the enhanced data structure further comprises to:
calculate a length of array for the requested array elements;
obtain an original local pointer to the requested array elements on the first system; and
obtain added metadata associated with the requested array elements.

20. The apparatus of claim 19, wherein the processor unit further executes the computer executable code to:
obtain a release array type call on the first system from the second system;
calculate an address of the enhanced data structure;
extract the original local pointer from the enhanced data structure;
call a local release function using the original local pointer with array elements and parameters previously passed; and
return a result from the local release function.
